(19) United States
(12) Patent Application Publication
(10) Pub. No.: US 2012/0215686 A1
(43) Pub. Date: Aug. 23, 2012

(54) METHOD AND SYSTEM FOR ENABLING A USER TO CREATE A DOCUMENT IN A COLLABORATIVE ENVIRONMENT

(75) Inventor: Marco Lauzon, Saint-Amable (CA)

(73) Assignee: LES CONTES PERPETUELS INC., Saint-Amable, QC (CA)

(21) Appl. No.: 13/504,116

(22) PCT Filed: Nov. 1, 2010
(86) PCT No.: PCT/CA10/01736

§ 371 Date: Apr. 25, 2012

Related U.S. Application Data
(60) Provisional application No. 61/257,705, filed on Nov. 3, 2009.

(51) Int. Cl. G06F 17/30; G06Q 20/28

(52) U.S. Cl. 705/39; 707/608; 707/E17.008

(57) ABSTRACT

A method is disclosed for enabling a user to create a document in a collaborative environment, the method comprising including a first user accessing an application for storing a document; the first user drafting a given part of a document which may comprise a plurality of additional parts on an interface displayed to the first user; selecting at least one other user which may add an additional part to the document and transmitting an invitation to the selected at least one other user, the invitation comprising including an object for performing at least one of visualizing a part of the document and adding an additional part to the document. At least one of the visualizing a part of the document and the adding of the additional part of the document may be done for a fee.

### CROSS-REFERENCE TO RELATED APPLICATION

This application claims priority of US provisional Patent Application N° 61/257,705 entitled “Creation of collaborative content and private publication system” that was filed on Nov. 3, 2009, the specification of which is hereby incorporated by reference.

### FIELD OF THE INVENTION

This invention relates to electronic publishing. More precisely, this invention pertains to a method and system for enabling a user to create a collaborative environment.

### BACKGROUND OF THE INVENTION

A user who wants to share content with authorized users can use instant messaging services (e.g. chat) or discussion forums which are free and require registration.

A user willing to publish content in many parts is usually required to publish the first part for reading by other users, and then the user publishes the next part and so on.

Unfortunately such embodiments may suffer from great limitations in some instances.

In fact, a third party may wish for instance to add content to an existing published content and may be restricted from doing so for various reasons. Moreover the accessing or the managing of the access may also be very complicated to do so especially if a large audience wishes to access to the content.

There is a need for a method that will overcome at least one of the above-identified drawbacks.

Features of the invention will be apparent from review of the disclosure, drawings and description of the invention below.

### BRIEF SUMMARY

According to one embodiment, there is provided a method for enabling a user to create a document in a collaborative environment, the method comprising a first user accessing an application for storing a document; the first user drafting a given part of a document which may comprise a plurality of additional parts on an interface displayed to the first user; selecting at least one other user which may add an additional part to the document and transmitting an invitation to the selected at least one other user, the invitation comprising an object for performing at least one of visualizing a part of the document and adding an additional part to the document.

In accordance with an embodiment, the document comprises an electronic book and the given part of the document comprises a paragraph.

In accordance with an embodiment, the application for storing a document comprises a web server for hosting the document.

In yet another embodiment, at least one of the visualizing a part of the document and the adding of the additional part to the document is done for a fee.

In an embodiment, the transmitting of an invitation to the selected at least one other user comprises sending a message to each of the selected at least one other user using one of an existing dedicated communication application and a social network service.

In yet another embodiment, the application is accessed locally using a processing unit.

In yet another embodiment, the first user drafting a given part of the document comprises the first user drafting a first paragraph of a story.

In yet another embodiment, the first user drafting a first paragraph of the story comprises the first user entering a title for the story, the first user selecting a category for the story and the first user entering the first paragraph for the story.

In yet another embodiment, the category is selected from a group consisting of adventure, comedy, romance, crime, science fiction, news and true life stories.

In yet another embodiment, the method further comprises checking if the first user is logged in.

In another embodiment, the method further comprises the first user providing a payment.

In yet another embodiment, the providing of the payment comprises one of providing a prepaid code and providing credit card payment information.

In yet another embodiment of the method, the providing of the prepaid code comprises providing an alphanumerical code associated with a number of allowed participations wherein each allowed participation provides an access to the story.

In another embodiment, the method further comprises displaying an error message if the number of allowed participation is equal to zero.

In yet another embodiment, the method further comprises subtracting one participation to the number of allowed participations when creating the story.

In yet another embodiment, the method further comprises generating an access code for accessing a given paragraph of the story, wherein the object comprises the access code.

In yet another embodiment, the object further comprises an URL for accessing the given part of the document.

In yet another embodiment, the object further comprises a reference number for the story.

In another embodiment, the method further comprises a receiving user of the at least one other user receiving the invitation.

In another embodiment, the method further comprises displaying specifications associated with the story to the receiving user.

In yet another embodiment, the method further comprises removing a write permission upon one of displaying the specifications associated to the story to the receiving user and the receiving user adding another paragraph to the story.

In yet another embodiment, the method further comprises the receiving user paying for adding another paragraph to the story.

In yet another embodiment, the method further comprises the receiving user paying for visualizing the story.

In yet another embodiment, the paying comprises the receiving user providing a prepaid code.

In yet another embodiment, part of revenues generated by the fees charged is provided to a third party, further wherein the invitation comprises a mention that part of the revenues will be provided to the third party.

In yet another embodiment, the third party comprises a charity financing a philanthropic cause.

In accordance with another embodiment, there is provided a system for enabling a user to create a document in a collaborative environment, the system comprising a document database for storing a document; a document access verifier operatively connected to the document database for selectively providing access to the document; a content controller operatively connected to the document access verifier for enabling a user to draft a given part of a document which may comprise a plurality of additional parts on an interface provided to the user and to further select at least one other user which may add an additional part to the document and an invitation providing module operatively connected to the document database for generating and transmitting an invitation to the selected at least one user, the invitation comprising an object for performing at least one of visualizing at least the given part of the document and adding an additional part to the document.

In accordance with another embodiment, the document comprises a story.

In accordance with another embodiment, the invitation providing module comprises an access code generator operatively connected to the document database, an access code database operatively connected to the document database and a document sender operatively connected to the access code database and to the document database.

### BRIEF DESCRIPTION OF DRAWINGS

In order that the invention may be readily understood, embodiments of the invention are illustrated by way of example in the accompanying drawings.

FIG. 1 is a flowchart which shows an embodiment of a method for enabling a user to create a document in a collaborative environment;

FIG. 2 is a flowchart which shows an embodiment of a method for creating a new story;

FIG. 3 is a flowchart describing payment methods for creating a story and sending invitations;

FIG. 4 is a flowchart describing an embodiment of a method for accessing a story;

FIG. 5 is a flowchart describing an embodiment of payment methods for continuing a story;

FIG. 6 is a flowchart describing an embodiment of a method for continuing and updating a story;

FIG. 7 is a flowchart describing an embodiment of a method for sending an invitation for a continuing story;

FIG. 8 is a flowchart describing an embodiment of a method for buying and generating a prepaid code;

FIG. 9 is a block diagram showing an embodiment of a process for accessing, registering, saving a story and sending invitations to create or continue a story;

FIG. 10 is a block diagram showing an embodiment of a process for verifying a content;

FIG. 11 is a block diagram illustrating an embodiment of a process for buying a participation or a prepaid code; and

FIG. 12 is a block diagram showing an embodiment of a process for completing a transaction.

Further details of the invention and its advantages will be apparent from the detailed description included below.

### DETAILED DESCRIPTION

In the following description of the embodiments, references to the accompanying drawings are by way of illustration of an example by which the invention may be practiced. It will be understood that other embodiments may be made without departing from the scope of the invention disclosed.

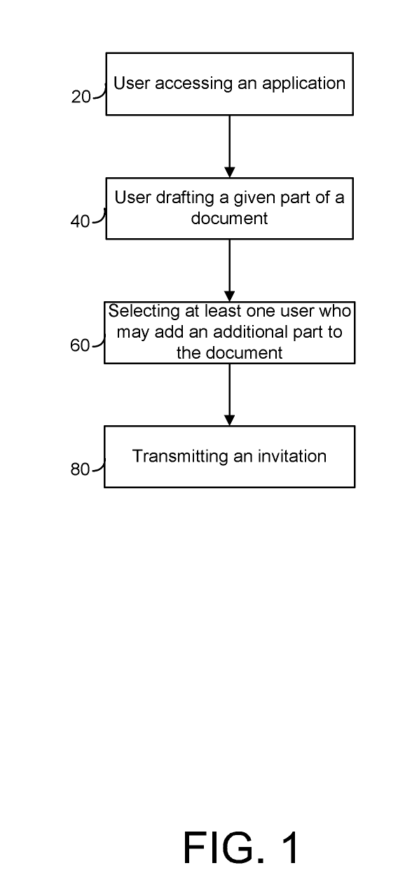

Now referring to FIG. 1, there is shown an embodiment of a method for enabling a user to create a document.

It will be appreciated that the document may be any type of document. In one embodiment the document comprises an electronic book. Moreover, the skilled addressee will appreciate that the document may comprise objects selected from a group consisting of pictures, texts, animations and videos.

According to processing step 20, a user accesses an application for storing a document. It will be appreciated that the user may access the application according to various embodiments. For instance, the user may access the application via a data network such as the Internet. In such embodiment, the application may comprise a webserver. Alternatively the user may access the application locally using a processing unit such as one of a laptop, a desktop, a smart phone and a tablet computer.

In fact, it will be appreciated that the application is used to store a document. The skilled addressee will appreciate that the storing of the document may be performed according to various embodiments. For instance, the storing may be performed locally or remotely from the user.

According to processing step 40, a given part of the document which may comprise a plurality of additional parts is drafted by the user on an interface displayed to the user. In one embodiment, the given part of the document comprises the first part of the document.

According to processing step 60, at least one user which may add an additional part to the document is selected. It will be appreciated that the at least one user may be selected according to various embodiments. In one embodiment, the email address corresponding to each of the at least one user is provided. In an alternative embodiment, other identification corresponding to each of the at least one user may be provided such as a login to a website.

According to processing step 80, an invitation is transmitted to the selected at least one user. In one embodiment the invitation comprises an object for performing at least one of visualizing a part of the document and adding an additional part to the document.

It will be appreciated that at least one of the visualizing a part of the document and the adding of the additional part to the document may be done for a fee.

Moreover it will be appreciated that in one embodiment the transmitting of the invitation may comprise sending a message to each of the selected at least one other user using one of an existing dedicated communication application and a social network service. Still in this embodiment, the message comprises an invitation.

It will be appreciated that the existing dedicated communication application may be an email application. In such embodiment, the message comprises an email. Alternatively, the existing dedicated communication application may be an instant message application.

It will be further appreciated that the social network service may be Facebook™ for instance.

The skilled addressee will appreciate that various alternative embodiments may be provided for the transmitting of the invitation.

It will be appreciated that in the following an embodiment of the method is disclosed wherein the document comprises a story and paragraphs may be added to an initial paragraph or a subsequent paragraph as explained above. The skilled addressee will appreciate that various alternative embodiments may be possible.

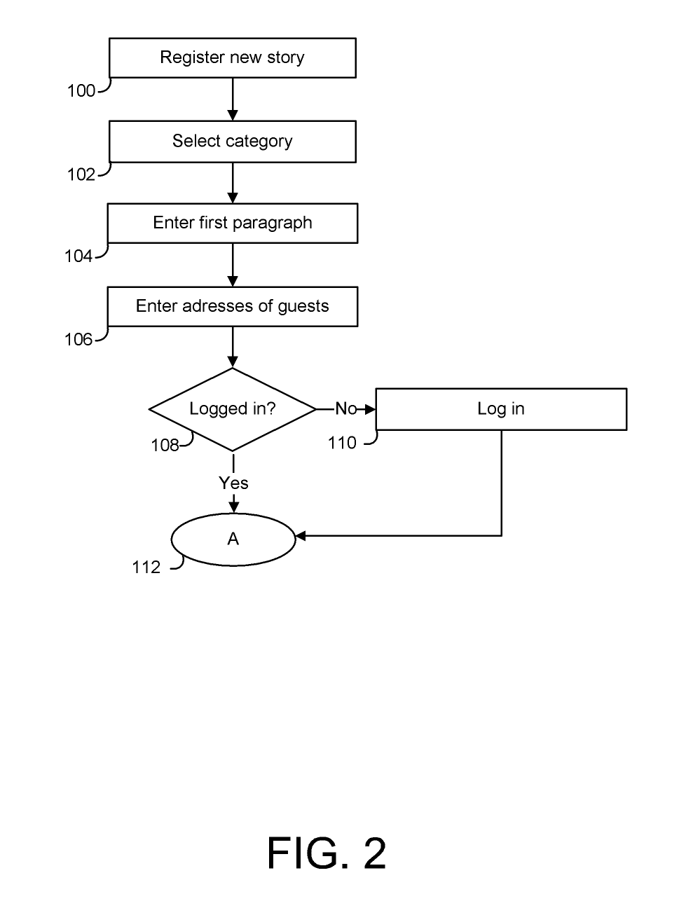

Now referring to FIG. 2, there is shown an embodiment of a method for creating a new story.

According to processing step 100, a user registers a new story by entering a title.

According to processing step 102, the user selects a category for the story. In one embodiment, the category may be selected from a group consisting of adventure, comedy, romance, crime, news, true life stories and science-fiction. The skilled addressee will appreciate that alternative embodiments may be provided.

According to processing step 104, the user enters a first paragraph for the story.

According to processing step 106, the user enters the email addresses of his guests and clicks a submit button. In an alternative embodiment, the user provides an identification of his guests and clicks the submit button.

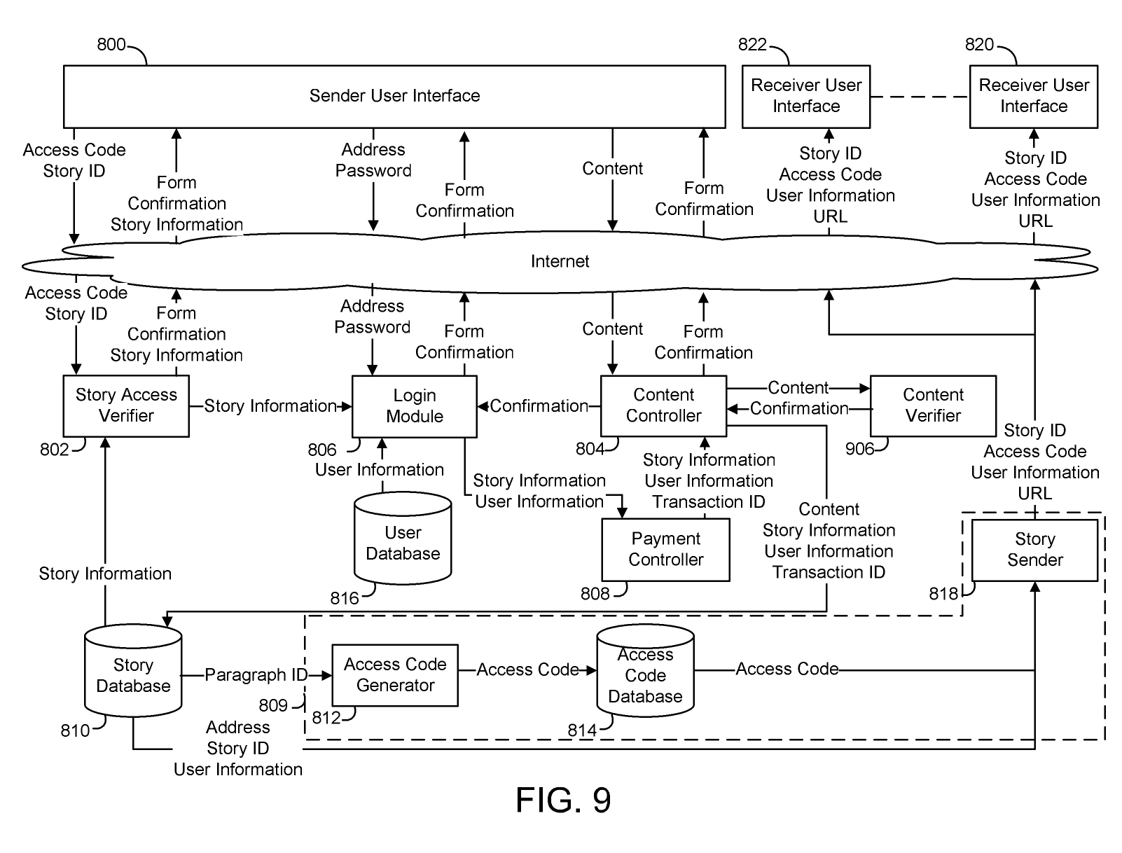

Now referring to FIG. 9, there is shown an embodiment of a system for enabling a user to create a document in a collaborative environment. In this particular embodiment, the document comprises a story. Still in this embodiment, the system comprises a document database, an embodiment of which is story database 810, for storing a document.

The system further comprises a document access verifier, an embodiment of which is the story access verifier 802, operatively connected to the document database 810 for selectively providing access to the document.

The system further comprises a content controller 804 operatively connected to the document access verifier 802 for enabling a user to draft a given part of a document which may comprise a plurality of additional parts on an interface provided to the user and to further select at least one other user which may add an additional part to the document.

The system further comprises an invitation providing module 809 operatively connected to the document database for generating and transmitting an invitation to the selected at least one user, the invitation comprising an object for performing at least one of visualizing at least the given part of the document and adding an additional part to the document.

In one embodiment, the invitation providing module 809 comprises an access code generator 812, an access code database 814 and a story sender 818.

More precisely, the invitation providing module comprises an access code generator 812 operatively connected to the document database, an embodiment of which is the story database 810 in FIG. 9, an access code database 814 operatively connected to the document database and a document sender, an embodiment of which is story sender 818, operatively connected to the access code database 814 and to the document database.

Still referring to FIG. 9 and in accordance with one embodiment, the content controller 804 provides a form to the sender user interface 800 which returns the content including the selected category, the text entered, including the title and the paragraph, and the email addresses (or other identification means for identifying a user) of the at least one guest.

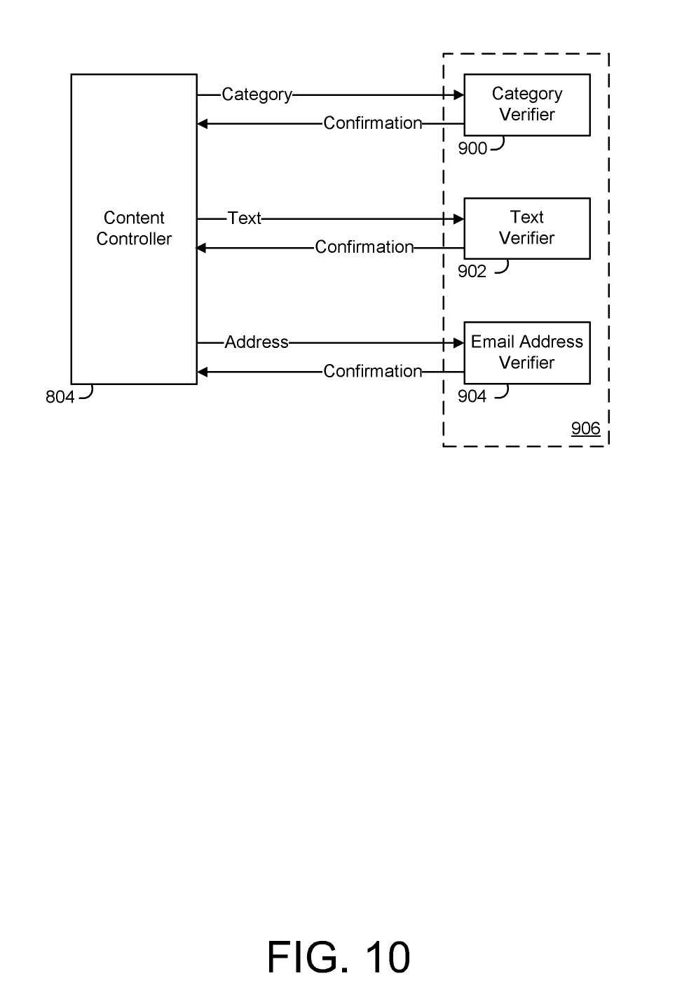

Now referring to FIG. 10, the content controller 804 provides the category, the text and the email addresses to respectively a category verifier 900, a text verifier 902 and an email address verifier 904 grouped in content verifier 906. The category verifier 900 checks that the category selected by the user is offered to the user and returns a confirmation, e.g. a signal or an error message, to the content controller 804.

The text verifier 902 is used for checking that the title contains in one embodiment less than 200 characters and the paragraph contains in one embodiment less than 600 characters and returns a confirmation, e.g. a signal or an error message, to the content controller 804. The skilled addressee will appreciate that various alternative embodiments may be provided for the text verifier 902. In particular the ranges provided above may change depending on a given application.

The email address verifier 904 ensures that all email addresses (or other identification means) are typed in the right format separated by semi-colons and returns a confirmation (e.g. a signal or an error message) to the content controller 804. The skilled addressee will appreciate that various embodiments of the email address verifier 904 may be provided.

Referring to FIG. 9, the content verifier 906 provides a confirmation, comprising a validating signal or any error messages to the content controller 804 which forwards the confirmation to the sender user interface 800. If a signal is returned to the content controller 804, the content controller 804 provides the signal to a login module 806.

Referring to FIG. 2, a test is performed according to processing step 108 in order to check if the user is logged in.

In the case where the user is logged in and according to processing step 112, the user accesses the payment forms by A. In the case where the user is not logged in and according to processing step 110, the user is invited to do so.

Now referring to FIG. 9, the login module 806 provides a form to the sender user interface 800 which returns an email address and a password in one embodiment. In other alternative embodiments, other type of information may be provided such as user name for instance. The login module 806 checks that the email address and the password exist in the user database 816 and that they refer to the same user ID. If not, the login module 806 returns a confirmation comprising an error to the sender user interface 800.

In the case where the email address and the password exist in the user database 816 and refer to the same user ID, a user database 816 returns the user information, comprising a user ID, a first name, a last name, an address, a country, a province or state and a postal or zip code to the login module 806 which forwards the user information to a payment controller 808 in one embodiment.

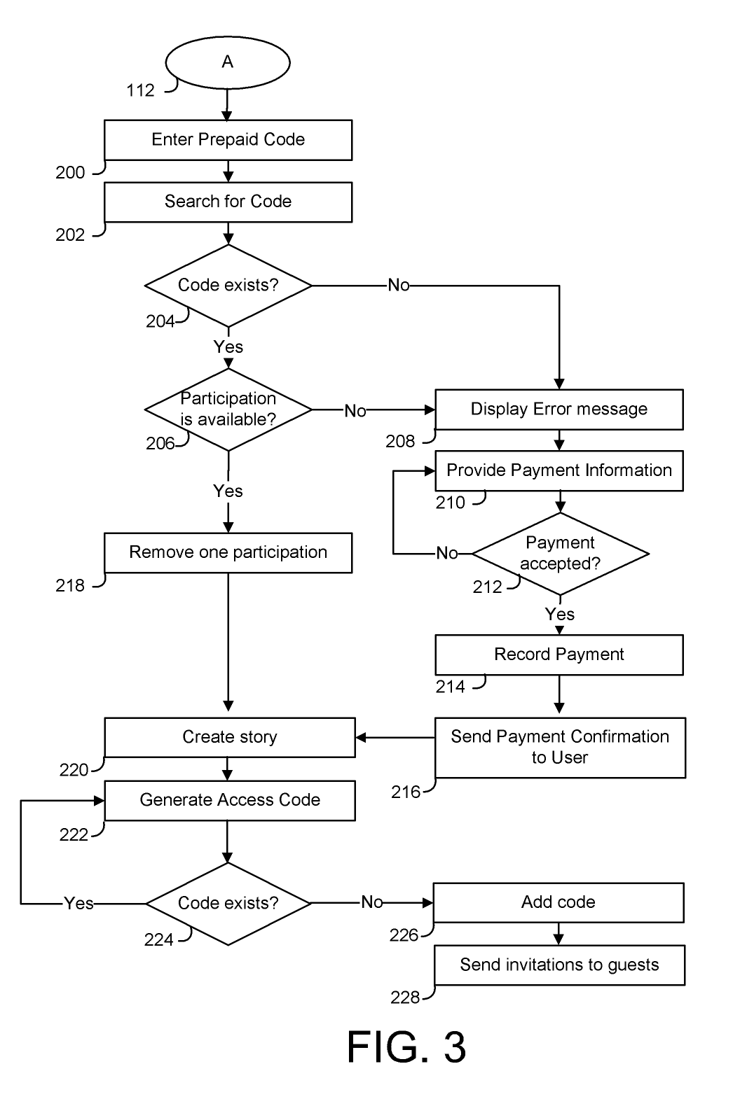

Now referring to FIG. 3, there is shown an embodiment of a payment method for creating a story and sending invitations.

It will be appreciated that the user may pay by prepaid code or by credit card in one embodiment. In fact the skilled addressee will appreciate that various alternative embodiments may be possible.

In one embodiment, a prepaid code comprises an alphanumerical code comprising 12 characters linked to a number of allowed participations. In an alternative embodiment, the prepaid code may comprise a bar code or the like. In such embodiment, the bar code is linked to a number of allowed participations. In this embodiment, each participation gives an access to a story to continue and the possibility to continue or begin a story. If the user wishes to pay using a prepaid code, the user enters a code in accordance with processing step 200.

The system searches for the code in accordance with processing step 202 by looking if the prepaid code exists in a database in accordance with processing step 204.

If the prepaid code exists and according to processing step 206, a test is performed to find out if a participation is available.

If the prepaid code does not exist and according to processing step 208, the system displays an error message.

If no participation is available, the system also displays an error message in accordance with processing step 208.

If a participation is available, the system removes one participation to the prepaid code in accordance with processing step 218 and creates the story in accordance with processing step 220.

In the case where the user pays using a credit card, the user provides payment information to the system, such as first name, last name, credit card number, card type and expiration date, in accordance with processing step 210.

The system checks if the payment is accepted in accordance with processing step 212.

In the case where the payment is accepted and in accordance with processing step 214, the system records the payment.

In the case where the payment is not accepted and in accordance with processing step 210, the user is invited to provide new payment information. Once the payment is recorded and in accordance with processing step 214, the system provides a payment confirmation to the user in accordance with processing step 216 and creates the story in accordance with processing step 220.

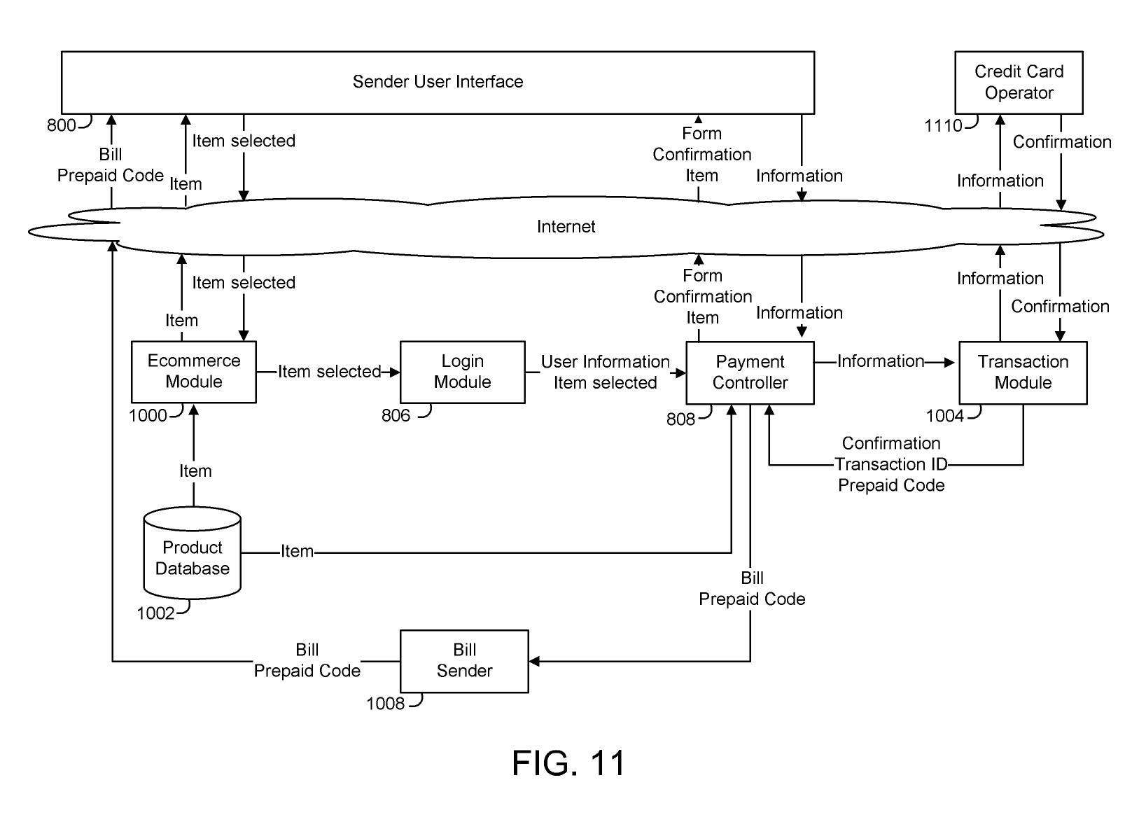

Now referring to FIG. 11 and in accordance with one embodiment, a product database 1002 provides an item comprising all details concerning one participation (e.g. product ID, title, description, price and taxable note) to the payment controller 808. The payment controller 808 provides the item and the form (e.g. prepaid code form and credit card form) to the sender user interface 800 which returns information about prepaid code or credit card.

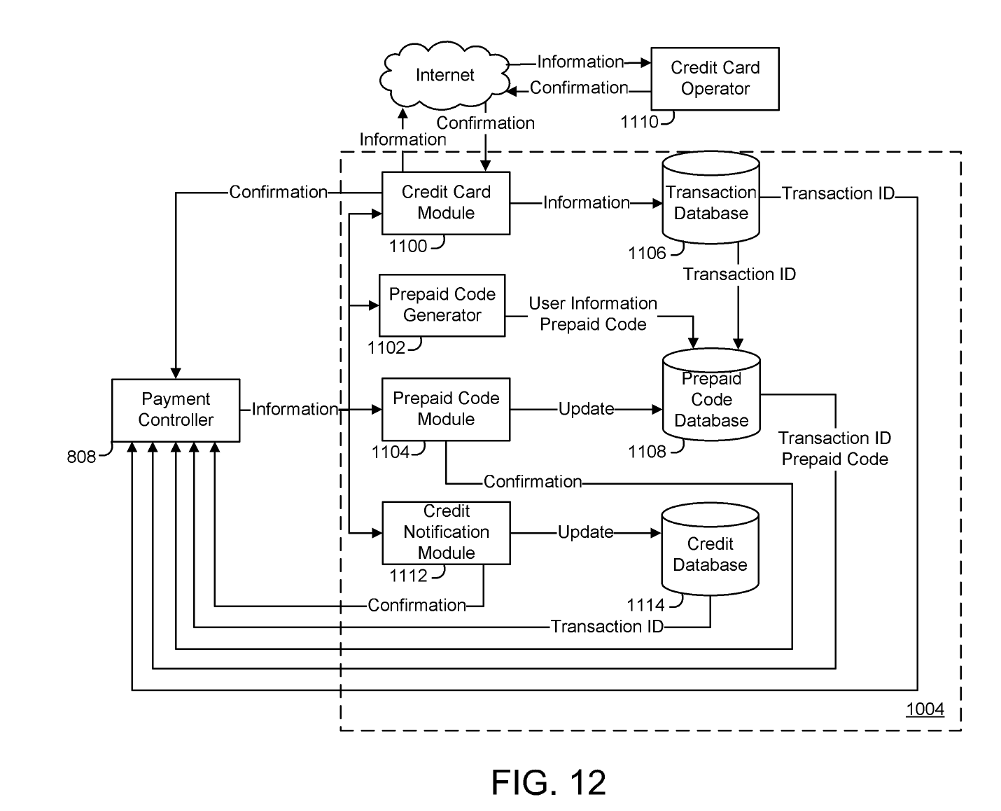

Now referring to FIG. 12 and in accordance with one embodiment, the payment controller 808 provides information comprising the prepaid code or credit card information and the user information to respectively a prepaid code module 1104 or a credit card module 1100. This comprises information, i.e. prepaid code or credit card information, from the sender user interface 800 and user information from the login module 806. The prepaid code module 1104 checks if the code exists and if at least one participation is available in a prepaid code database 1108 for the code.

If a participation is available, the prepaid code module 1104 provides a signal to update the prepaid code, by removing one participation, in the prepaid code database 1108 which returns the transaction ID, corresponding to the prepaid code, to the payment controller 808.

If the code does not exist or if no participation is available, i.e. empty code, the prepaid code module 1104 returns a confirmation comprising an error message to the payment controller 808.

The credit card module 1100 provides information to a credit card operator 1110 which processes the information and returns a confirmation, i.e. transaction accepted or refused for some reasons. The credit card module 1100 processes that information and returns a confirmation comprising an error message to the payment controller 808 if the transaction is refused by the credit card operator 1110. If the transaction is accepted, the credit card module 1100 provides information, i.e. transaction and user details, to a transaction database 1106. The transaction database 1106 returns the transaction ID to the payment controller 808.

Referring to FIG. 11, if the payment controller 808 receives a confirmation comprising an error message from the transaction module 1004, by the prepaid code module 1104 or the credit card module 1100, the payment controller 808 forwards that confirmation to the sender user interface 800.

If the payment controller 808 receives the transaction ID from the transaction module 1004, by the prepaid code database 1108 or by the transaction database 1106, the payment controller 808 prepares the bill and provides it to a bill sender 1008. The bill sender 1008 prepares the message which contains the bill and provides the bill to the sender user interface 800.

Referring now to FIG. 9, the payment controller 808 provides the user information, from the login module 806, and the transaction ID, from the transaction module 1004, to the content controller 804 which provides that information, the content (grouping the category, the text (title and paragraph) and email addresses of guest) to a story database 810 which saves a new story referring to the user ID and the transaction ID.

Referring back to FIG. 3, once the story is updated and according to processing step 222, an access code is generated by the system. The access code comprises a unique alphanumerical code of about eight characters referring to a specific paragraph in one embodiment.

A test is performed in accordance with processing step 224 to find out if the code exists in the database. In the case where the code does exit the system generates another code.

In the case where the code does not exist and in accordance with processing step 226, the system adds the code to the database and provides invitations to guests by email (or other means) in accordance with processing step 228.

Referring now to FIG. 9, the story database 810 provides the email addresses of guests (or other identification means for identifying guests), story ID and user information, comprising first name and last name, to a story sender 818. The story database 810 provides also the paragraph ID, corresponding to the paragraph that the user has just written, to an access code generator 812 which generates a unique code and provides it to an access code database 814. The access code database 814 saves the code and provides the code to the story sender 818. The story sender 818 uses the received data to create a message including story ID, access code, user information, i.e. first name and last name, and URL, i.e. an http address referring to a web page allowing access to the paragraph that the user has just written. The story sender 818 provides these data by email to guests i.e. receiver user interface 820, receiver user interface 822 and so on. Alternatively, these data may be provided to guests using other communication means. For instance, these data may be provided to an existing account directly.

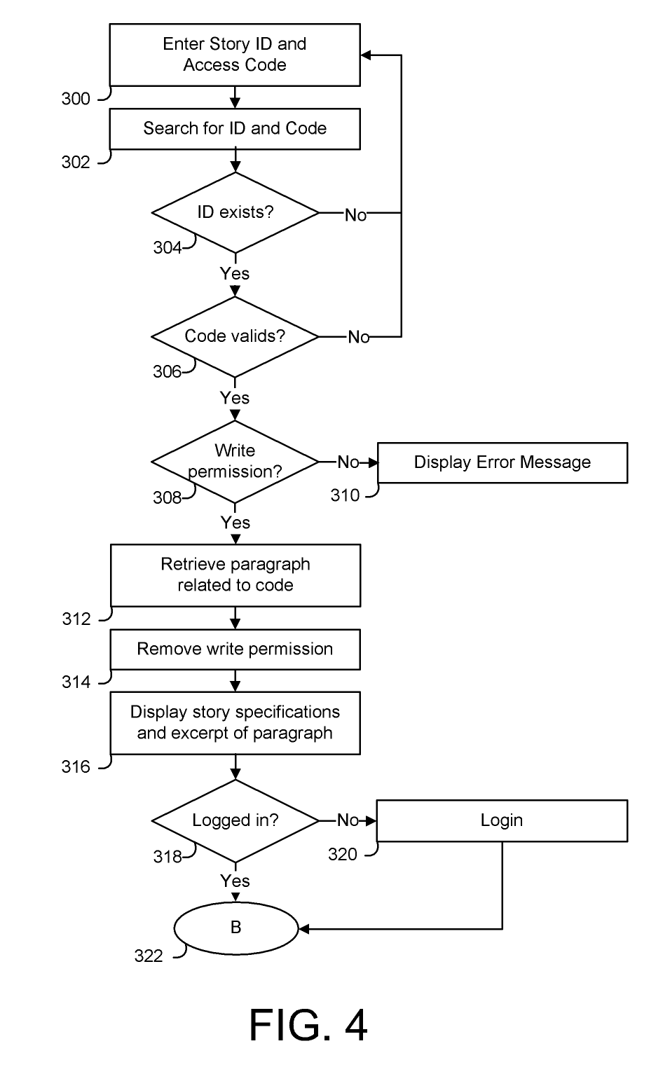

Now referring to FIG. 4, the guest, hereinafter referred to as the user, has received an invitation message which contains information comprising first name and last name of the host, the story ID, i.e. the reference number to the story inside which the paragraph's host figures, and the access code (corresponding to the paragraph's host). The user enters the story ID and the access code in accordance with processing step 300. The skilled addressee will appreciate that the data mentioned above may be replaced by a single data string placed in an URL provided to the user.

In accordance with processing step 302, the system searches for the story ID and the access code in the database.

In accordance with processing step 304, a test is performed in order to find out if the story ID does exist or not.

In accordance with processing step 306, a test is performed in order to find out if the access code is valid or not; i.e. it does not exist or it does not link to the story ID.

In the case where the access code is not valid and in accordance with processing step 300, the user is invited to enter a new story ID or access code.

In accordance with processing step 308 and in the case where the story ID exists and the access code is valid, the system asks for write permission to the database.

If the story is in writing process, i.e. a user is currently continuing that story, an error message is displayed in accordance with processing step 310.

If the story is available for writing and in accordance with processing step 312, the system retrieves the paragraph related to the access code.

In accordance with processing step 314, the system removes the write permission. This means that the story cannot be continued by another user until the user has finished writing or until a time allowed for writing has expired, i.e. after 3 hours without any action from the user in accordance with one embodiment. The skilled addressee will therefore appreciate that the removing of the write permission may be performed upon one of displaying the specifications associated to the story to a guest and the guest adding another paragraph to the story.

In accordance with processing step 316, the system displays the story specifications referring to the story ID, i.e. title, category, first name and last name of the author of the first paragraph and creation date, and the excerpt of the paragraph related to the access code, i.e. the first part of the paragraph.

Referring now to FIG. 9, a story access verifier 802 provides a form to the sender user interface 800 which returns the story ID and the access code. The story access verifier 802 ensures that the story ID exists, the access code exists and is linked to the story ID and if there is a write permission associated to the story ID in the story database 810.

If the story ID does not exist or if the access code does not exist or is not linked to the story ID or if there is no write permission, the story access verifier 802 returns a confirmation comprising an error message to the sender user interface 800.

If the story ID exists, the access code exists and is linked to the story ID and there is write permission, the story database 810 provides the story information, including the story ID, story category, the title, the creation date, the paragraph ID corresponding to the access code, all paragraphs, the first name and last name of the author of each paragraph, the number of allowed participations and the maximum number of allowed participations corresponding to the story ID, to the story access verifier 802.

The story access verifier 802 provides an excerpt of the paragraph corresponding to the access code to the sender user interface 800 and the story information to the login module 806. The login module 806 provides a form to the sender user interface 800 which returns an email address and a password. The skilled addressee will appreciate that various embodiments of the login module 806 may be provided.

The login module 806 checks that the email address and the password exist in the user database 816 and refer to the same user ID.

If this is not the case, the login module 806 returns a confirmation comprising an error message to the sender user interface 800. If this is the case, the user database 816 returns the user information, comprising user ID, first name, last name, address, country, province or state and postal or zip code, to the login module 806.

Referring to FIG. 4, the system verifies if the user is logged in, in accordance with processing step 318.

If the user is not logged in and in accordance with processing step 320, the user is invited to log.

If the user is logged in and in accordance with processing step 322, the user accesses to B.

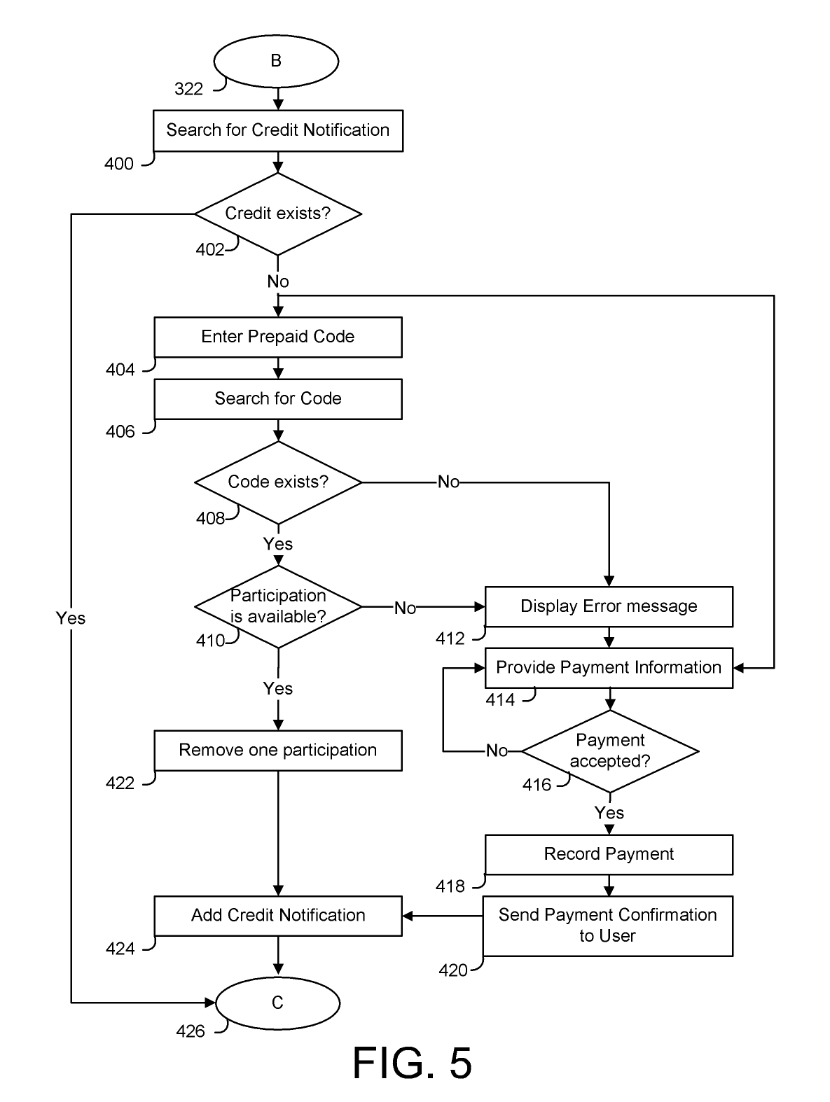

Referring now to FIG. 5, there is shown a flowchart describing payment methods for continuing a story.

In accordance with processing step 400, the system searches for credit notification.

In accordance with processing step 402, the system checks the database to find out if a credit referring to the user and the current paragraph exists. A credit lasts when a user has paid to access and continue a story but has quit before registering his paragraph or his story.

In the case where a credit exists, the user goes to C in accordance with processing step 426.

If a credit does not exist, the user can pay by prepaid code or by credit card. If the user pays by prepaid code, the user enters a prepaid code in accordance with processing step 404.

The system searches for code at processing step 406 by checking if the code exists in the database at processing step 408. If the code exists and in accordance with processing step 410, the system checks if a participation is available. If the code does not exist and in accordance with processing step 412, the system displays an error message. It will be appreciated that if a participation is available, the system removes one participation to the prepaid code in accordance with processing step 422, adds a credit notification in accordance with processing step 424 and go to C in accordance with processing step 426. If no participation is available and in accordance with processing step 412, the system displays an error message. If the user pays by credit card and in accordance with processing step 414, the user provides payment information to the system. In accordance with processing step 416, the system checks if the payment is accepted. If the payment is accepted and in accordance with processing step 418, the system records the payment. If the payment is not accepted and in accordance with processing step 414, the user has to provide new payment information. Once the payment is recorded and in accordance with processing step 420, the system provides a payment confirmation to the user, adds a credit notification in accordance with processing step 424 and goes to C in accordance with processing step 426.

Now referring to FIG. 9, the login module 806 provides user information and story information to the payment controller 808. As shown in FIG. 11, the payment controller 808 forwards the user information and story information to the transaction module 1004. Product database 1002 provides an item comprising here all details concerning one participation, i.e. product ID, title, description, price and taxable note, to the payment controller 808 which forwards the item to the sender user interface 800.

Referring now to FIG. 12, the payment controller 808 provides information including the user ID and paragraph ID to a credit notification module 1112. The credit notification module 1112 checks if a credit is linked to the user ID and corresponds to the paragraph ID in a credit database 1114. If this is the case, the credit database 1114 returns the transaction ID to the payment controller 808. If this is not the case, the credit notification module 1112 provides a confirmation comprising a refused signal to the payment controller 808.

Referring back to FIG. 11 and if there is no credit, the payment controller 808 provides form, i.e. prepaid code form and credit card form, to the sender user interface 800 which returns information, i.e. prepaid code or credit card information.

Referring now to FIG. 12, the payment controller 808 provides information to one of the prepaid code module 1104 and the credit card module 1100. This information comprises information, i.e. prepaid code or credit card information, from sender user interface 800 and user information from the login module 806. The prepaid code module 1104 checks if the code exists and if one participation is available in the prepaid code database 1108. If a participation is available, the prepaid code module 1104 provides a signal to update the prepaid code, by removing one participation, in the prepaid code database 1108 which returns the transaction ID corresponding to the prepaid code. If the code does not exist or if no participation is available, i.e. empty code, the prepaid code module 1104 returns a confirmation comprising an error message to the payment controller 808.

The credit card module 1100 provides information to the credit card operator 1110 which processes the information and which returns a confirmation, i.e. transaction accepted or refused for some reasons. The credit card module 1100 handles that information and returns a confirmation comprising an error message to the payment controller 808 if the transaction is refused by the credit card operator 1110. If the transaction is accepted, the credit card module 1100 provides information, i.e. transaction and user details, to the transaction database 1106. The transaction database 1106 returns the transaction ID to the payment controller 808.

Referring now to FIG. 11, if the payment controller 808 receives a confirmation comprising an error message from the transaction module 1004, by the prepaid code module 1104 or the credit card module 1100, the payment controller 808 forwards the confirmation to the sender user interface 800. If the payment controller 808 receives the transaction ID from the transaction module 1004, by the prepaid code database 1108 or the transaction database 1106, the payment controller 808 prepares and provides the bill to the bill sender 1008. The bill sender 1008 prepares the message which contains the bill and provides it to the sender user interface 800.

Now referring to FIG. 12 and considering the user had no credit and his payment has been accepted, the payment controller 808 provides information which contains the user ID and the paragraph ID to the credit notification module 1112. The credit notification module 1112 updates the credit database 1114 by saving a credit associated to the paragraph ID and to the user ID. The credit notification module 1112 provides a confirmation comprising a signal to the payment controller 808.

As shown in FIG. 9, the payment controller 808 provides the story information, from the login module 806, the user information, from the login module 806, and the transaction ID, from the transaction module 1004, to the content controller 804.

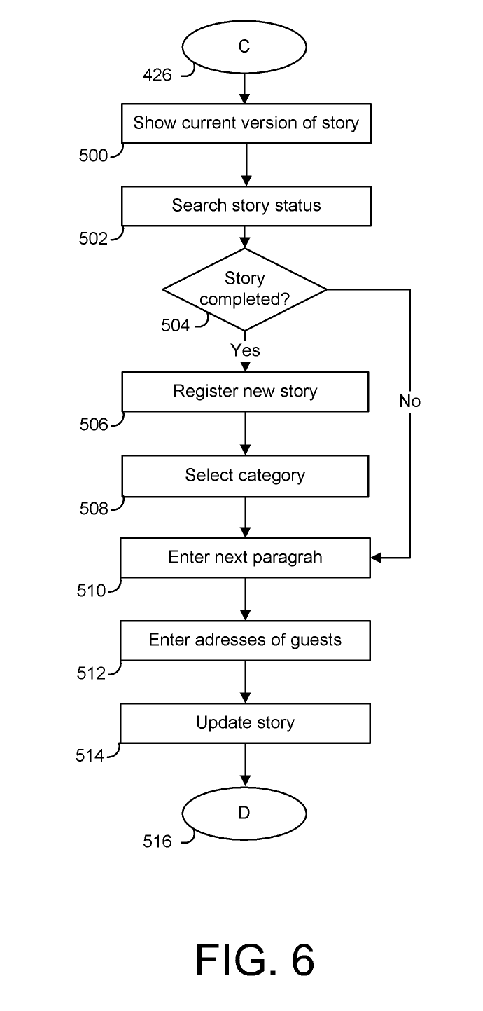

FIG. 6 shows an embodiment of a method for continuing and updating a story. Once the payment of a participation is confirmed (resulting a credit, a prepaid code or a credit card payment), the system shows the current version of the story in processing step 500, i.e. story specifications, such as for instance title, category, author, date of creation as well as any other participating author, if any, all paragraphs composing the story and the first name and last name of the author of each paragraph.

In accordance with processing step 502, the system searches for the story status. In accordance with processing step 504 a check is performed in the database to find out if the story is completed.

If the story is completed and in accordance with processing step 506, the user has to register a new story; that could be a new chapter of the last story, by entering a title.

In accordance with processing step 508, the user selects a category.

In accordance with processing step 510, the user enters the next paragraph, i.e. the first paragraph in that case.

If the story is not completed and in accordance with processing step 510, the user has to enter the next paragraph of the current story.

In both cases and in accordance with processing step 512, the user enters email addresses of his guests (or other identification means) and clicks submit button to update, or create, the story in accordance with processing step 514 and further attend D in processing step 516.

Referring now to FIG. 9, the content controller 804 checks the story status, i.e. if the story is completed or not, by checking the number of allowed participations and the maximum number of allowed participations associated to the story ID. The content controller 804 provides an appropriate form, to create a story, if the story is completed, or to continue a story, if the story is not completed, to the sender user interface 800 which returns the content (grouping the category and the text (title and paragraph) depending the story status and email addresses of guest (or other identification means for identifying a guest)). The content controller 804 forwards the content to the content verifier 906.

Referring to FIG. 10, the content controller 804 dispatches the category, the text and email addresses (or other identification means for identifying a guest) respectively to the category verifier 900, text verifier 902 and email address verifier 904 grouping in the content verifier 906. The category verifier 900 ensures that the category selected by the user is one of the choices offered to the user and returns a confirmation, i.e. a signal or an error message, to the content controller 804. The text verifier 902 ensures that the title contains less than about 200 characters and the paragraph contains less than about 600 characters and returns a confirmation, i.e. a signal or an error message, to the content controller 804. In one embodiment, the email address verifier 904 ensures that all email addresses (or other identification means for identifying a guest) are typed in a right format separated by semi-colons and returns a confirmation, i.e. a signal or an error message, to the content controller 804. Alternatively, the email address verifier 904 checks that all email addresses are valid, i.e. they exist. In the case where user names are provided, the email address verifier 904 checks that the user names are valid.

Referring now to FIG. 9, the content verifier 906 provides the confirmation, comprising any error messages from a verifier, to the content controller 804 which forwards that confirmation to the sender user interface 800. If a signal is returned to the content controller 804, the content controller 804 provides the content (grouping the category, the text (title and paragraph) and email addresses of guests (or other identification means for identifying a guest)), the story information, the user information and the transaction ID to the story database 810 which update (save) the story.

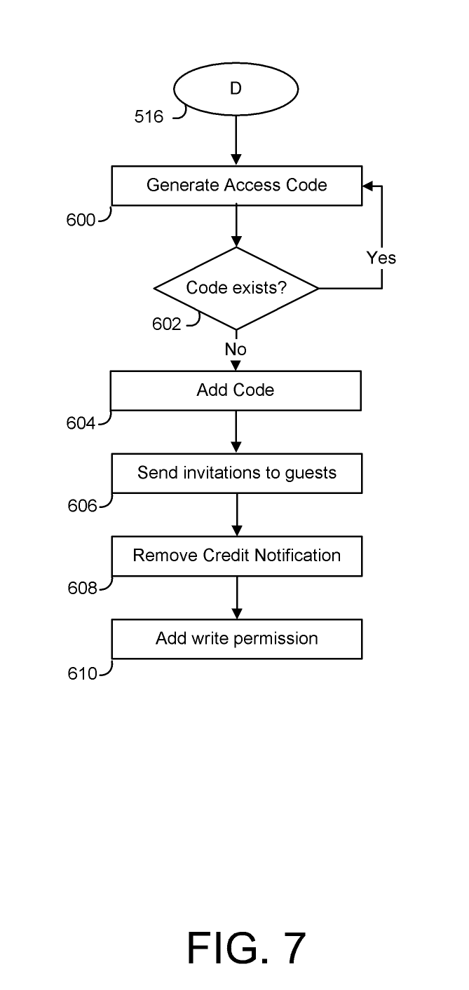

FIG. 7 shows an embodiment of a method for sending an invitation for a continuing story. Once the story is updated and in accordance with processing step 600, the system generates an access code. If the code exists in the database and in accordance with processing step 602, the system generates another code until the code doesn't exist. If the code does not exist in the database and in accordance with processing step 604, the system adds the code to the database. In accordance with processing step 606, the system provides invitations to guests by email or other means as further mentioned above. In accordance with processing step 608, the system removes the credit notification and adds permission to write in accordance with processing step 610.

Referring now to FIG. 9, the story database 810 provides email addresses of guests (or other identification means for identifying a guest) in one embodiment, story ID and user information, i.e. first name and last name, to the story sender 818. The story database 810 provides the paragraph ID to the access code generator 812 which generates a unique code and provides it to the access code database 814. The access code database 814 provides that access code to the story sender 818. The story sender 818 uses the received data to create a message including story ID, access code, user information, i.e. first name and last name, and URL. The story sender 818 provides those data by email, in one embodiment, to guests: receiver user interface 820, receiver user interface 822 and so on.

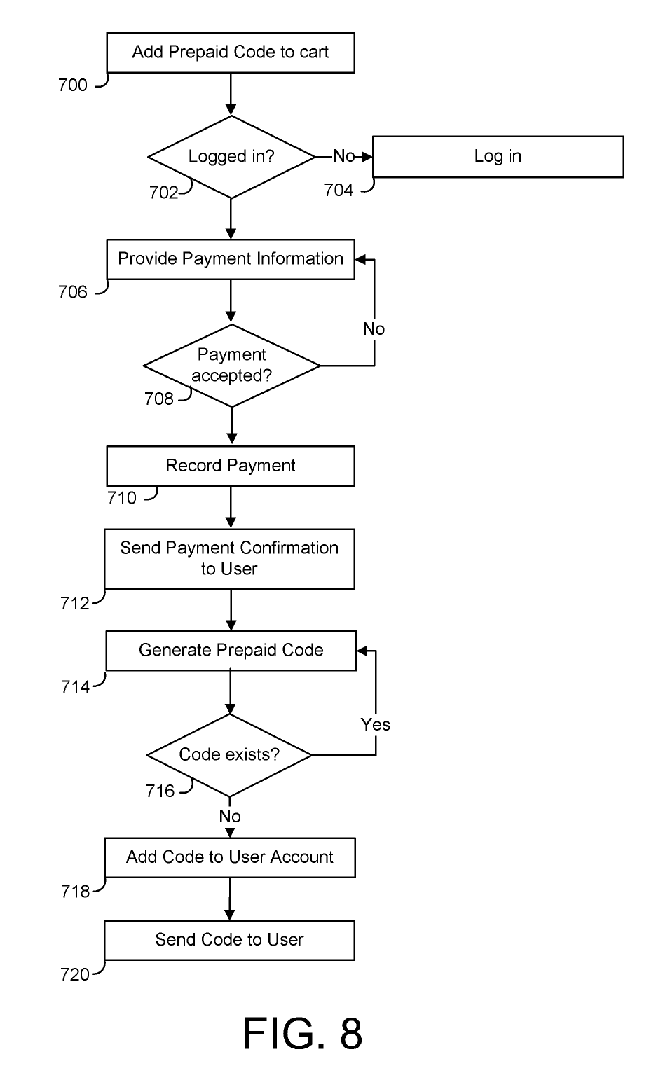

FIG. 8 shows an embodiment of a method for buying and generating a prepaid code.

In accordance with processing step 700, the user adds prepaid code to his cart. In accordance with processing step 702, the system checks if the user is logged in. If the user is not logged in and in accordance with processing step 704, the user is invited to log in, and register to the web site if necessary.

If the user is logged in and in accordance with processing step 706, the user has to provide payment information, for instance credit card information in one embodiment. Alternative embodiments known to the skilled addressee may be used for providing the payment information

In accordance with processing step 708, the system checks if the payment is accepted. If the payment is accepted and in accordance with processing step 710, the system records the payment. If the payment is not accepted and in accordance with processing step 706, the user has to provide new payment information.

Once the payment is recorded and in accordance with processing step 712, the system provides a payment confirmation to the user.

In accordance with processing step 714, the system generates a prepaid code.

If the code generated exists and in accordance with processing step 716, a new code is generated.

If the code generated does not exist and in accordance with processing step 718, the code is added to the user account.

In accordance with processing step 720, the code is provided to the user.

Referring now to FIG. 11, the product database 1002 provides available items (i.e. prepaid code) to an E-commerce Module 1000 which forwards the available items to the sender user interface 800. The sender user interface 800 provides the selected items to the E-commerce module 1000. The E-commerce module 1000 provides the selected items to the login module 806.

Referring now to FIG. 9, the login module 806 provides a form to the sender user interface 800 which returns an email address and a password. The login module 806 checks that the email address and the password exist in the user database 816 and refer to the same user ID.

If this is not the case, the login module 806 returns a confirmation comprising an error message to the sender user interface 800.

If this is the case, the user database 816 returns the user information, i.e. user ID, first name, last name, address, country, province or state and postal or zip code, to the login module 806.

Referring now to FIG. 11, the login module 806 provides user information and items selected to the payment controller 808. The payment controller 808 provides form, i.e. credit card form, to the sender user interface information 800 which returns information, i.e. credit card information.

Referring now to FIG. 12, the payment controller 808 provides information, i.e. credit card information from the sender user interface 800 and user information from the login module 806, to the credit card module 1100. The credit card module 1100 provides information to the credit card operator 1110 which handles the information and returns a confirmation, i.e. transaction accepted or refused for some reasons. The credit card module 1100 handles that information and returns a confirmation comprising an error message to the payment controller 808 if the transaction is refused by the credit card operator 1110. If the transaction is accepted, the credit card module 1100 provides information, i.e. transaction and user details, to the transaction database 1106. The transaction database 1106 returns the transaction ID to the payment controller 808. The payment controller 808 provides the user information, the number of prepaid code items and the number of allowed participations that they contain as information to a prepaid code generator 1102. The prepaid code generator 1102 generates one unique code for each prepaid code item, i.e. the prepaid code generator 1102 verifies each code in the prepaid code database to ensure that each code is unique. The prepaid code generator 1102 provides the user information, i.e. the user ID, and prepaid code to the prepaid code database 1108 which saves prepaid codes linked to the user ID. The prepaid code database 1108 returns prepaid codes to the payment controller 808.

Referring now to FIG. 11, if the payment controller 808 has received a confirmation comprising an error message from the transaction module 1004, by the credit card module 1100, the payment controller 808 forwards the confirmation to the sender user interface 800. If the payment controller 808 has received the transaction ID, by the transaction database 1106, and the prepaid code, by the prepaid code database 1108, from the transaction module 1004, the payment controller 808 prepares and provides the bill with the prepaid codes to the bill sender 1008. The bill sender 1008 prepares the message which contains the bill and prepaid code(s) before sending it to the sender user interface 800.

It will be appreciated that in one embodiment, the system disclosed herein may be used for funding a charity financing a given philanthropic cause for instance. The skilled addressee will appreciate that the funding may not be limited to a philanthropic cause and may also comprise the funding of projects in general.

In such embodiment, a first user is provided with a given “prepaid” code used for generating the first paragraph. Such given “prepaid” code will be used to identify that the story is used for financing the given philanthropic cause. In fact, it will be appreciated that preferably this given “prepaid” code will be provided for free to the first user to start the story.

In fact, each user visualizing a part of the story will in one embodiment see a mention that part of the revenues generated using this story will be used for financing the cause and will be invited to contribute by adding a paragraph to the story. The revenues may be generated by either visualizing the story or contributing to the story. The skilled addressee will appreciate that in one embodiment each user receiving the invitation for performing at least one of visualizing a part of the story and adding an additional part to the story will see the mention that part of the revenues will be used for financing the cause.

After a given period, a share of the revenues will be provided to a third party for the purpose of the financing of the cause. The skilled addressee will appreciate that this embodiment is of great advantage for financing a cause.

Although the above description relates to a specific embodiments as presently contemplated by the inventor, it will be understood that the invention in its broad aspect includes functional equivalents of the elements described herein.

1. A method for enabling a user to create a document in a collaborative environment, the method comprising:
a first user accessing an application for storing a document;
the first user drafting a given part of a document which may comprise a plurality of additional parts on an interface displayed to the first user;
selecting at least one other user which may add an additional part to the document;
transmitting an invitation to the selected at least one other user, the invitation comprising an object for performing at least one of visualizing a part of the document and adding an additional part to the document
wherein at least one of the visualizing a part of the document and the adding of the additional part of the document is done for a fee.

2. The method as claimed in claim 1, wherein the document comprises an electronic book and wherein the given part of the document comprises a paragraph.

3. The method as claimed in claim 1, wherein the application for storing a document comprises a webserver for hosting the document.

4. (canceled)

5. The method as claimed in claim 1, wherein the transmitting of an invitation to the selected at least one other user comprises sending a message to each of the selected at least one other user using one of an existing dedicated communication application and a social network service.

6. The method as claimed in claim 1, wherein the application is accessed locally using a processing unit.

7. The method as claimed in claim 2, wherein the first user drafting a given part of the document comprises the first user drafting a first paragraph of a story.

8. The method as claimed in claim 7, wherein the first user drafting a first paragraph of the story comprises the first user entering a title for the story, the first user selecting a category for the story and the first user entering the first paragraph for the story.

9. The method as claimed in claim 8, wherein the category is selected from a group consisting of adventure, comedy, romance, crime, science fiction, news and true life stories.

10. The method as claimed in claim 7, further comprising checking if the first user is logged in.

11. The method as claimed in claim 10, further comprising the first user providing a payment.

12. The method as claimed in claim 11, wherein the providing of the payment comprises one of providing a prepaid code and providing credit card payment information.

13. The method as claimed in claim 12, wherein the providing of the prepaid code comprises providing an alphanumerical code associated with a number of allowed participations wherein each allowed participation provides an access to the story.

14. The method as claimed in claim 13, further comprising displaying an error message if the number of allowed participation is equal to zero.

15. The method as claimed in claim 13, further comprising subtracting one participation to the number of allowed participations when creating the story.

16. The method as claimed in claim 7, further comprising generating an access code for accessing a given paragraph of the story, wherein said object comprises said access code.

17. The method as claimed in claim 1, wherein said object further comprises an URL for accessing the given part of the document and a reference number for the story.

18. (canceled)

19. The method as claimed in claim 7, further comprising a receiving user of the at least one other user receiving said invitation.

20. The method as claimed in claim 7, further comprising displaying specifications associated with said story to the receiving user.

21. The method as claimed in claim 7, further comprising removing a write permission upon one of displaying the specifications associated to said story to the receiving user and the receiving user adding another paragraph to the story.

22. (canceled)

23. (canceled)

24. (canceled)

25. (canceled)

26. (canceled)

27. A system for enabling a user to create a document in a collaborative environment, the system comprising:
a document database for storing a document;
a document access verifier operatively connected to the document database for selectively providing access to the document;
a content controller operatively connected to the document access verifier for enabling a user to draft a given part of a document which may comprise a plurality of additional parts on an interface provided to the user and to further select at least one other user which may add an additional part to the document;
an invitation providing module operatively connected to the document database for generating and transmitting an invitation to the selected at least one user, the invitation comprising an object for performing at least one of visualizing at least the given part of the document and adding an additional part to the document.

28. (canceled)

29. (canceled)
